(19) United States
(12) Patent Application Publication
(10) Pub. No.: US 2017/0166057 A1
(43) Pub. Date: Jun. 15, 2017

(54) INFOTAINMENT SYSTEMS FOR A VEHICLE

(71) Applicant: FORD GLOBAL TECHNOLOGIES, LLC, Dearborn, MI (US)

(72) Inventor: Andrew John MURRAY, Colchester (GB)

(73) Assignee: FORD GLOBAL TECHNOLOGIES, LLC, Dearborn, MI (US)

(21) Appl. No.: 15/372,923

(22) Filed: Dec. 8, 2016

(30) Foreign Application Priority Data
Dec. 11, 2015 (GB) 1521872.0

(51) Int. Cl. B60K 35/00; G06F 3/041; G06F 3/0484; G06F 3/0488

(52) U.S. Cl. CPC B60K 35/00; G06F 3/04883; G06F 3/0416; G06F 3/04842; B60K 2350/1028; B60K 2350/106; B60K 2350/352; B60K 2350/405

(57) ABSTRACT

An infotainment system is provided for use in a vehicle. The system comprises a screen configured to provide vehicle information and/or entertainment content. The screen is a touchscreen configured to enable the user to select content. A track is configured to enable the lateral movement of the screen from a first position laterally displaced from a centerline of the vehicle to a second position on the vehicle centerline.

### CROSS-REFERENCE TO RELATED APPLICATIONS

This application claims foreign priority benefits under 35 U.S.C. §119(a)-(d) to GB 1521872.0 filed Dec. 11, 2015, which is hereby incorporated by reference in its entirety.

### TECHNICAL FIELD

This disclosure relates to improvements in or relating to infotainment systems for a vehicle and, in particular, to displays provided to enable the driver to view and interact with various information and infotainment systems.

### BACKGROUND

In order to comply with the law, drivers must have access to certain information concerning the vehicle such as the speed at which the vehicle is travelling. Additionally, there is an increasing range of information and systems with which the driver and/or passenger may wish to interact with under certain circumstances.

Furthermore, it is known to provide an infotainment system within a vehicle that, in addition to providing information to the driver, may interface with a satellite navigation system and/or mobile telephone in addition to controlling the climate within the vehicle and may provide entertainment content to the driver and any passengers within the vehicle.

It is against this background that the present disclosure has arisen.

### SUMMARY

According to the present disclosure there is provided an infotainment system for a vehicle, comprising a screen configured to provide vehicle information and/or entertainment content, wherein the screen is a touch screen configured to enable the user to select content, and a track configured to enable the lateral movement of the screen from a first position behind a steering wheel of the vehicle, laterally displaced from a centerline of the vehicle to a second position on the vehicle centerline.

The vehicle information may be safety information, which may include that information required by legislation to be displayed. This may include, but is not limited to a display indicating the speed of the vehicle, the safety system status, an odometer, or trip computer.

Alternatively or additionally, vehicle information may include one or more of the following: location and route information provided in conjunction with a satellite navigation system; control and management of a mobile telephone; and control and management of the climate control system.

The entertainment content may include music and/or video content, either live received via a suitable transponder and streamed to the screen or stored on a memory device within the vehicle and accessed from that location.

The memory device may be located permanently within the vehicle or it may be temporarily located within the vehicle and connected, for example, via Bluetooth® to the vehicle. For example, the memory device may be the user's mobile phone.

The first position may be adjacent to or behind a steering wheel. In this position the screen is the sole display from which the driver receives information. As such, when the screen is in this position, it must display all mandatory information, typically at least the speed of the vehicle. In addition, it may provide further data with either a purely informational function or additionally an entertainment function. By relying primarily on a single screen rather than having a separate multifunction screen in the vehicle cluster, the overall cost of the displays can be reduced. It may even be possible to completely dispense with the display within the cluster, provided that the legal requirements for driver information can be met by the infotainment system screen.

User interaction with the infotainment system may be provided by virtue of the screen being a touchscreen. This is now an intuitive interface for the majority of users.

The system may further comprise at least one controller for interfacing with the system. The controller may be a stalk and it may be used in addition to the touchscreen functionality or it may be provided as an alternative only usable when interface with the touchscreen is impractical or dangerous due to the position of the screen behind the steering wheel.

Alternatively or additionally, the controller may be embodied as one or more buttons provided near the centerline of the vehicle. These buttons may control the screen remotely when it is behind the steering wheel and align below the screen when the screen is located on the vehicle centerline.

The track may extend to the opposite side of the centerline from the steering wheel. The track primarily enables the screen to be moved from the centerline of the vehicle to a position behind the steering wheel. However, in order to accommodate left and right hand drive vehicles it may be practical to provide a track that extends equally to both sides of the centerline. This has the additional benefit that the screen may be moved to a position in front of a front seat passenger. This may enable the front seat passenger to watch a movie without distracting the driver.

The track may extend substantially horizontally. The track may be configured in such a way to be masked by surrounding trim features so that it is substantially invisible to the user or it may be integrated within a more prominent and visible trim feature. This ensures that the track does not have a negative effect on the perceived quality or appearance of the vehicle interior.

The screen may comprise a latching mechanism that enables the user, in a single movement, to unlatch and move the screen from a first position to a second position and vice versa.

According to another aspect of the present invention there is provided an infotainment system for a vehicle, comprising: a primary screen configured to provide vehicle information and/or entertainment content; a secondary screen configured to provide vehicle information; and a track configured to enable the lateral movement of the primary screen from a first position to a second position, wherein, the secondary screen is fixed in the first position and obscured by the primary screen when the primary screen is in the first position.

The first position may be behind a steering wheel of a vehicle. In this position the primary screen is the sole display from which the driver receives information. As such, when the primary screen is in this position, it must display all mandatory information, typically at least the speed of the vehicle. In addition, it may provide further data with either a purely information or additionally an entertainment function.

The second position may be located on or around the vehicle centerline. In this position the primary screen is one of two displays which the driver receives information from. The primary screen displays entertainment content (although it can also still display vehicle information) and the secondary screen displays mandatory vehicle information, typically at least the speed of the vehicle.

The primary screen may be further movable to a third position located on the opposite side of the vehicle centerline to the vehicle steering wheel. In this position the primary screen is easily accessible by a passenger to enable the passenger to clearly view entertainment content without distracting the driver of the vehicle

The primary screen may be a touchscreen configured to enable a user to select vehicle information and/or entertainment content.

The touchscreen capability of the primary screen may be at least partially disabled when the primary screen is in the first position. When the primary screen is in the first position it is not desirable for the driver to be able to access entertainment content or use the primary screen as a touch screen. Such behavior would distract the driver's attention away from the road. Disabling the touch screen capability would force the driver to move the primary screen to the second position in order to utilize the touch screen to select information and/or content.

The disclosure will now be further and more particularly described, by way of example only, and with reference to the accompanying drawings, in which:

### BRIEF DESCRIPTION OF THE DRAWINGS

FIG. 1 shows an embodiment of the present disclosure with the screen in a first position; and

FIG. 2 shows an embodiment of the present disclosure with the screen in a second position.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

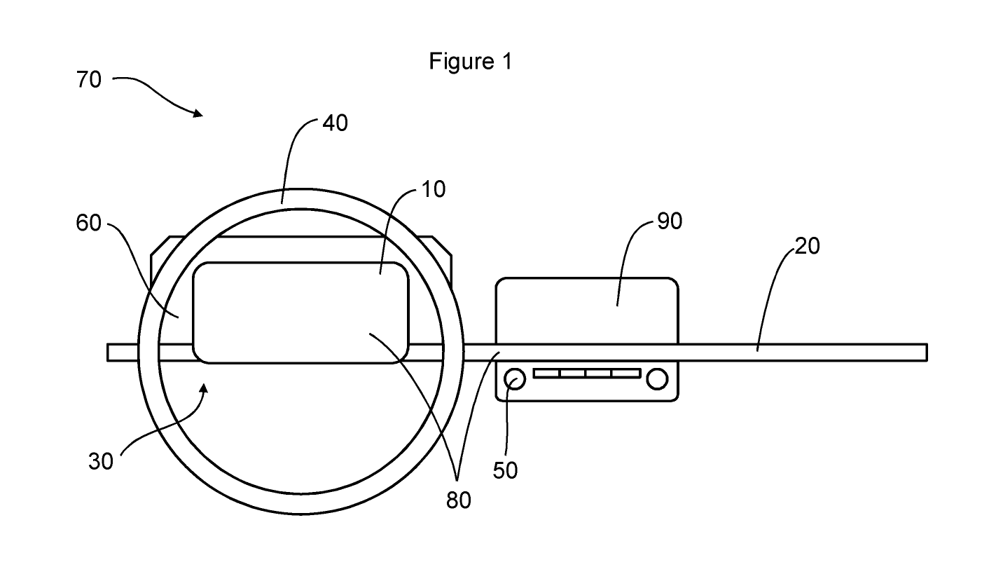

FIG. 1 shows part of the interior of a vehicle 70 comprising a steering wheel 40 with a cluster 60 incorporating a small, secondary display 65 behind the steering wheel 40. There is provided an infotainment system 80 comprising a screen 10 mounted on a track 20 that runs substantially horizontally from a centerline of the vehicle 70. The screen 10 of the infotainment system 80 is the primary display within the vehicle, with the display 65 having only a secondary importance, displaying mandatory data when the screen 10 of the infotainment system 80 is not displaying this data.

In FIG. 1 the screen 10 is located in a first position 30 behind a steering wheel 40. The screen 10 obscures the display 65. When the screen 10 is in the first position 30, the touch screen capability is at least partially disabled. The limited functionality retained may replicate the user's familiar interaction with a standard vehicle cluster in enabling the resetting of the odometer, for example. Instead of controlling the system 80 via the screen 10, the user interfaces with the system 80 via a series of controls 50. The controls 50 may be simple buttons, or dials or a combination of these functions, either within a single control 50 or across the series of controls provided. In the illustrated embodiment, the controls 50 are provided on the centerline of the vehicle.

The track 20 takes the form of a decorative insert that is perceived by the user to be part of the styling and is not “visible” as a track. The track 20 extends substantially horizontally to either side of the vehicle centerline. This may allow the same track 20 to be used whether the vehicle is left or right hand drive.

The screen 10 is provided with a latch or suitable detent mechanism (not shown). The latch is configured to be operable one-handed by the user to unlatch the screen from the first position and move it to the second position and vice versa. It is preferred that the unlatching and moving of the screen 10 should be one continuous movement.

The screen 10 also acts as a closure for a stowage 90. The stowage 90 is open when the screen 10 is moved to the first position, behind the steering wheel 40.

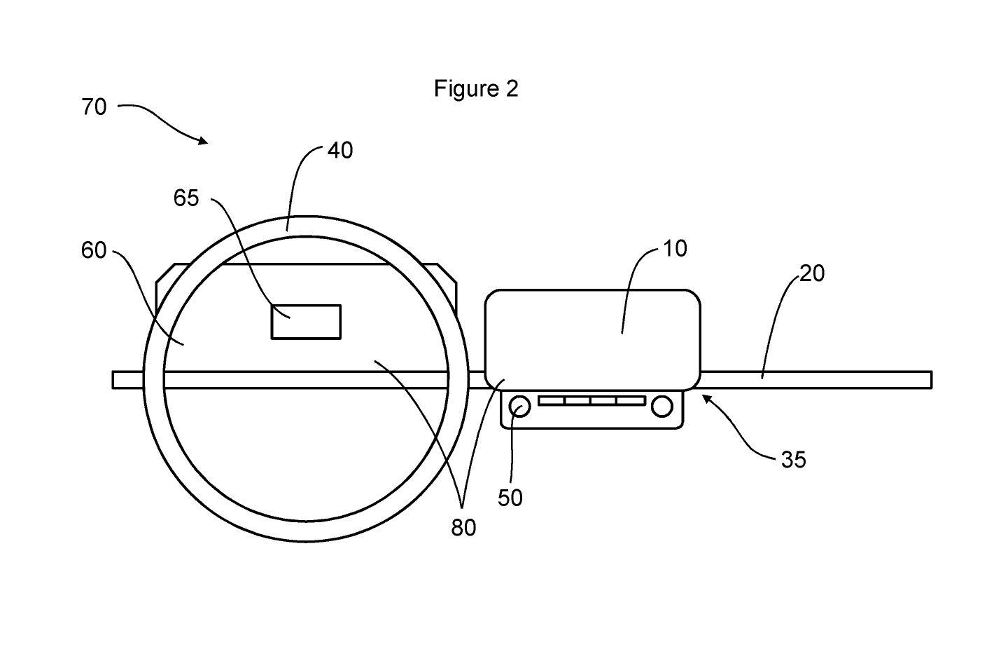

FIG. 2 shows the same part of the vehicle 70 as illustrated in FIG. 1 and the integers have been labelled with like reference numerals between the two figures. The screen 10 is located in a second position 35 on or around the vehicle centerline. Once the screen 10 is in the second position 35, the touch screen capability is fully enabled.

Depending on the overall Human Machine Interface strategy on the vehicle, the system 80 may be configured to accept only touchscreen 10 inputs or it may continue to operate additionally via the controls 50 provided on or around the centerline.

The majority of the interaction with the screen 10 is anticipated to be when interfacing with the satellite navigation functionality. As this should be undertaken when the vehicle is stationary, the screen 10 would typically be in the second position 35 and the touch screen functionality would be fully enabled.

FIG. 2 shows a secondary display 65 showing critical vehicle information such as vehicle speed. The extent of the information shown on the display will be dictated by the legal requirements in different territories, but it is to be kept to a minimum. In some embodiments, the display 65 may be obsolete and may therefore be absent.

In some embodiments, not illustrated in the accompanying figures, the functionality of the controls 50 may be replaced or replicated by one or more stalks on the steering wheel 40.

In some embodiments, a third position may be provided, wherein the screen can be moved to the opposite side of the vehicle centerline from the steering wheel. This allows the screen to be used by a front seat passenger, for example for watching a movie without distracting the driver.

It will further be appreciated by those skilled in the art that although the disclosure has been described by way of example with reference to several embodiments it is not limited to the disclosed embodiments and that alternative embodiments could be constructed without departing from the scope of the disclosure as defined in the appended claims.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. An infotainment system for a vehicle, comprising
a screen configured to provide vehicle information and entertainment content,
wherein the screen is configured to enable the user to select vehicle information or entertainment content, and
a track configured to enable the lateral movement of the screen from a first position behind a steering wheel of the vehicle to a second position on the vehicle centerline.

2. The system according to claim 1, wherein the vehicle information is safety information.

3. The system according to claim 1, wherein the vehicle information is location information provided in conjunction with a satellite navigation system.

4. The system according to claim 1, wherein the vehicle information relates to climate control within the vehicle.

5. The system according to claim 1, wherein the entertainment content includes music and video content.

6. The system according to claim 1, wherein the screen is a touchscreen.

7. The system according to claim 1, further comprising at least one controller for interfacing with the system.

8. The system according to claim 1, wherein the screen is further movable along the track to a third position located on the opposite side of the centerline from the steering wheel.

9. The system according to claim 1, wherein the track extends substantially horizontally.

10. The system according to claim 1, wherein the screen further comprises a latching mechanism for locking the screen in the first or second position.

11. An infotainment system for a vehicle, comprising
a primary screen configured to provide vehicle information and/or entertainment content;
a secondary screen configured to provide vehicle information; and
a track configured to enable lateral movement of the primary screen from a first position to a second position,
wherein, the secondary screen is fixed at the first position and obscured by the primary screen when the primary screen is in the first position.

12. The infotainment system according to claim 11, wherein the first position is behind a steering wheel of a vehicle.

13. The infotainment system for a vehicle according to claim 11, wherein the second position is located proximate to the vehicle centerline.

14. The infotainment system for a vehicle according to claim 12, wherein the primary screen is further movable to a third position located on the opposite side of the vehicle centerline to the steering wheel.

15. The infotainment system for a vehicle according to claim 11, wherein the primary screen is a touchscreen configured to enable a user to select the vehicle information and/or entertainment content via contact with the primary screen.

16. The infotainment system for a vehicle according to claim 15, wherein the touchscreen capability of the primary screen is at least partially disabled when the primary screen is in the first position.

17. A vehicle comprising:
a steering wheel disposed to one side of the vehicle;
an infotainment system including primary and secondary screens, each configured to provide vehicle information and entertainment content; and
a horizontal track supporting lateral movement of the primary screen between a first position behind the steering wheel and a second position adjacent a vehicle centerline.

18. The vehicle according to claim 17 further comprising a controller configured to, in response to contact with either of the screens, alternate between vehicle information or entertainment content.

19. The vehicle according to claim 17, wherein the primary screen provides a greater screen area than a screen area of the secondary screen.

20. The vehicle according to claim 17, wherein the infotainment system is configured to display vehicle speed to the primary screen responsive to the primary screen being in the first position and to display vehicle speed to the secondary screen responsive to the primary screen being in the second position.
